(19) United States
(12) Patent Application Publication
(10) Pub. No.: US 2022/0371271 A1
(43) Pub. Date: Nov. 24, 2022

(54) 3D PRINTING MODULES WITH BUILD PLATFORM DRIVING MECHANISMS

(71) Applicant: Hewlett-Packard Development Company, L.P., Spring, TX (US)

(72) Inventor: Heribert Farreny Agras, Sant Cugat del Valles (ES)

(21) Appl. No.: 17/775,572

(22) PCT Filed: Dec. 20, 2019
(86) PCT No.: PCT/US2019/067962

§ 371 Date: May 9, 2022

(51) Int. Cl. B29C 64/241; B33Y 30/00; B29C 64/295; B33Y 50/02; B29C 64/393; B29C 64/25

(52) U.S. Cl. CPC B29C 64/241; B33Y 30/00; B29C 64/295; B33Y 50/02; B29C 64/393; B29C 64/25

(57) ABSTRACT

A 3D printing module, a build unit and a method are disclosed herein. The 3D printing module comprises a build unit receiving interface to receive a build unit. The build unit comprises a build platform with a build platform drive interface. The 3D printing module further comprises a driving mechanism engageable with the build platform drive interface to controllably move the build platform.

### BACKGROUND

Some additive manufacturing or three-dimensional printing systems comprise a removable build unit that interacts with different 3D printing system sub-systems. Some build units comprise a build chamber defining a volume where 3D objects are generated. The build chamber comprises a build platform in its inner volume to perform a 3D printing operation in interaction with the 3D printing sub-system in which the build unit resides.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1A is a schematic diagram showing an example of a 3D printing module.

FIG. 1B is a schematic diagram showing an example of another 3D printing module.

FIG. 2A is a flowchart of an example method for interacting the build unit in the 3D printing module.

FIG. 2B is a flowchart of another example method for interacting the build unit in the 3D printing module.

FIG. 3 is a flowchart of another example method for engaging the build unit in the 3D printing module.

FIG. 4 is a schematic diagram showing an example of a front view of another 3D printing module.

FIG. 5 is a schematic diagram showing an example of a front view of a 3D printer.

FIG. 6 is a flowchart of another example method for generating a part of 3D object by a 3D printer.

FIG. 7 is a flowchart of another example method for executing a 3D printing operation by a build material processing station.

FIG. 8 is a schematic diagram showing an example of a cross-section view of a build unit.

### DETAILED DESCRIPTION

The following description is directed to various examples of additive manufacturing, or three-dimensional printing, apparatus and processes to generate high quality 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

3D printing systems generate a 3D object by executing a series of 3D printing operations. In some 3D printing systems some of the 3D printing operations are distinct from each other, and may be executed by different sub-systems of the 3D printing system. The sub-systems may be different depending on the type of material and 3D printing technology used. Some sub-systems may be physically placed in different locations. Other sub-systems may be integrated into a single housing.

In some examples, a removable build unit may be attached and detached from the different sub-systems according to the 3D printing system workflow. A build unit may be understood as the module including a build chamber where 3D objects are to be generated during the 3D printing process of a 3D printing system.

Some examples of 3D printing operations may include one or more of loading the removable build unit with build material, heating part of the build unit, selectively solidifying portions of build material from the build unit, ejecting agents (e.g., binding agents, fusing agents) to portions of the build material from the build unit, curing the contents of a build unit (e.g., thermally or UV curing), thermally fusing the portions of build material in which fusing agents have been deposited, separating non-solidified build material from the generated 3D objects (i.e., decaking), recycling non-solidified build material, removing 3D objects from the build unit, cleaning the build unit, and the like.

Some examples of sub-systems which may perform one or more of the printing operations mentioned above may include a build material processing station, a 3D printer, a curing station, a cleaning station, a decaking station and the like.

Some examples of 3D systems generate 3D objects by selectively process layers of build material. Suitable powder-based build materials for use in additive manufacturing may include, where appropriate, at least one of polymers, metal powder or ceramic powder. In some examples non-powdered build materials may be used such as gels, pastes, and slurries.

As mentioned above, build units are often attached to and detached from different sub-systems in which different 3D printing operations are executed. Typical build units are technically complex independent modules that interact with the different sub-systems of a 3D system. Build units comprise a moveable build platform therein to assist in the 3D printing operations execution. Some build units comprise additional mechanisms to further assist in the 3D printing operations execution. For example, some build units comprise heaters (e.g., resistive heater or heating blankets) to transfer heat to the contents of the build unit and thereby maintain them at a constant or controlled temperature. Build units also comprise a build platform drive mechanism to cause the movement of the build platform.

A single build unit may be used by different sub-systems to perform different printing operations. Some build unit elements and mechanisms are expensive and are not used in every single sub-system that the build unit interacts with. For this reason, some expensive build unit mechanisms have large downtime throughout the 3D printing workflow.

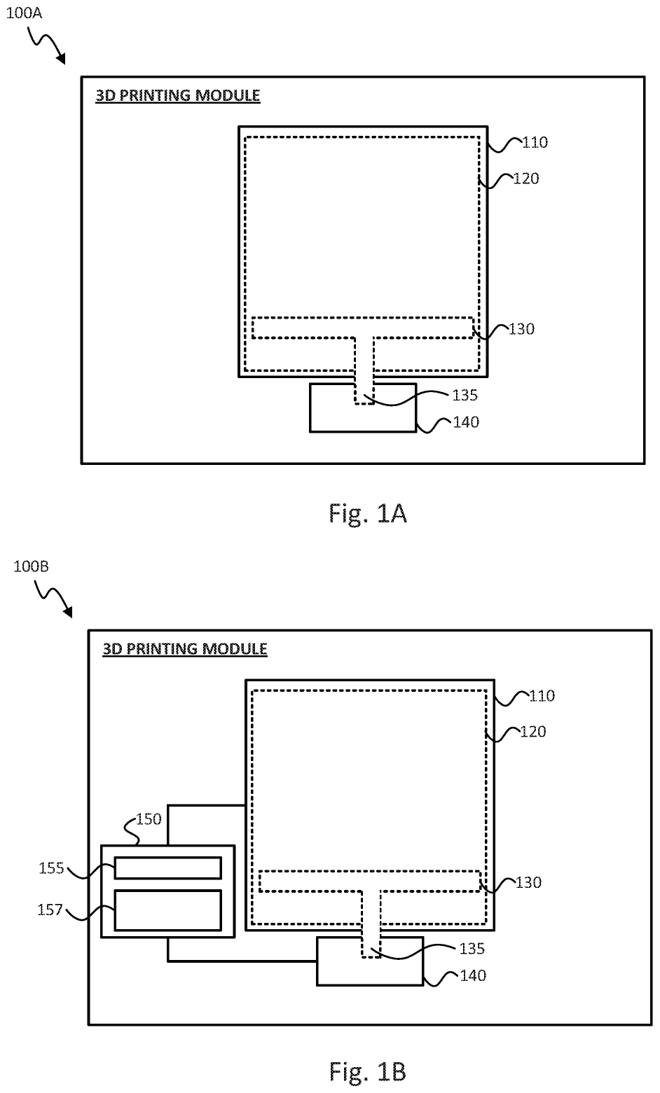

Referring now to the drawings, FIG. 1A is a schematic diagram showing an example of a vertical cross-section of a 3D printing module 100A. The 3D printing module 100A may, for example, be part of a build material processing station, a 3D printer, a curing station, a cleaning station, a decaking station or the like.

The 3D printing module 100A comprises a build unit receiving interface 110 and a build platform drive interface 140.

The build unit receiving interface 110 is an enclosure to receive a build unit 120 therein. In some examples, the build unit receiving interface 110 further comprises locking elements (not shown) to lock the build unit 120 in the build unit receiving interface 110. Some examples of locking elements may include latches, pins, or any mechanism capable to hold or secure the build unit 120 in the appropriate position within the build unit receiving interface 110.

Some elements in the examples shown herein are drawn in dotted lines (e.g., build unit 120) to indicate that the elements are external from the 3D printing module 100A, but also that such elements interact with the 3D printing module 100A in some way.

The build unit 120 is a receptacle defining a volume therein, referred to as build chamber. In some examples, part of the volume in the build unit 120 is designated to contain a reservoir of build material to be used during some 3D printing operations. The build chamber comprises a build platform 130 therein where 3D objects are to be generated thereon. The build platform 130 may substantially span a full horizontal surface of the build chamber. The build unit 110 enables the generation of layers of build material to be formed on the build platform 130. In some examples, the newly formed uppermost layer of build material may be selectively solidified (or partially solidified) thereby being a part of the 3D printed object that is being generated. The build platform 130 further comprises a build platform drive interface 135. A more detailed example of a build unit 120 is illustrated in FIG. 8 of the present disclosure.

The driving mechanism 140 is engageable with the build unit 120 through the build platform drive interface 135 to controllably move the build platform 130. In the illustrated example, the driving mechanism 140 may move the build platform 130 vertically (i.e., up and down).

In some examples, the driving mechanism 140 may be connected to a rotating device, such as a motor (not shown). The connection between the driving mechanism 140 and the rotating device may be a direct connection or an indirect connection. In some examples, an indirect connection may include an additional intermediate element therebetween. In the examples, the rotating device may cause the driving mechanism 140 to rotate and move the build platform 120 based on the angular speed and the angular direction. The angular speed of the rotation may cause the build platform to move at a lower or higher speed. The angular direction of the rotation may cause the build platform to move in a first direction (e.g., vertically upwardly) or in the second direction, the second direction being opposite to the first direction (e.g., vertically downwardly).

The driving mechanism 140 may be implemented in a number of different ways. In an example, the driving mechanism 140 may automatically engage with the build platform 130 upon the insertion of the build platform 130 into the 3D printing module 100. In this example, the driving mechanism 140 may be a passive element which receives the build platform drive interface 135 from the build platform 130 as the build unit 120 is inserted into the build unit receiving interface 110. In an example, the driving mechanism 140 and the build platform drive interface 135 may engage in a protrusion and cavity manner such as a plug and socket manner. Additionally, the driving mechanism 140 and the build platform drive interface 135 may engage with the build platform 130 (and the associated build platform drive interface 135) through relative motion between the driving mechanism 140 and the build platform drive interface 135. The relative motion may cause an automatic engagement between the driving mechanism 140 and the build platform drive interface 135 upon the insertion of the build unit 120 into the 3D printing module 100A. In alternative examples, the driving mechanism 140 may comprise a drive wheel, a gear in a fixed position or similar mechanical approaches.

In other examples, the driving mechanism 140 may engage with the build platform 130 in a controlled and active manner (see, e.g. FIG. 1B below).

FIG. 1B is a schematic diagram showing another example of a vertical cross-section of a 3D printing module 100B. The 3D printing module 100B comprises the driving mechanism 140 and the build unit receiving interface 110 to receive a build unit 120 therein.

In the example, the driving mechanism 140 may engage with the build platform drive interface 135 in an active and controlled manner. The engagement between the driving mechanism 140 and the build platform drive interface 135 may be through a latching mechanism, a grip mechanism, a pin mechanism, or any controllable mechanism suitable for attaching and detaching the driving mechanism 140 and the drive interface 135 in a controlled manner.

In these examples, the 3D printing module 100B may further comprise a controller 150. The controller 150 comprises a processor 155 and a memory 157 with specific control instructions to be executed by the processor 155. The controller 150 may be coupled to the build unit receiving interface 110 and the driving mechanism 140 (or the rotating device connected to the driving mechanism 140). The controller 150 may control the engagement between the driving mechanism 140 and the build platform drive interface 135 and the movement of the build platform 130 within the build unit 120. The functionality of the controller 150 is described further below.

In the examples herein, a controller may be any combinations of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller may be, at least partially, implemented in the form of an electronic circuitry. The controller may be a distributed controller, a plurality of controllers, and the like.

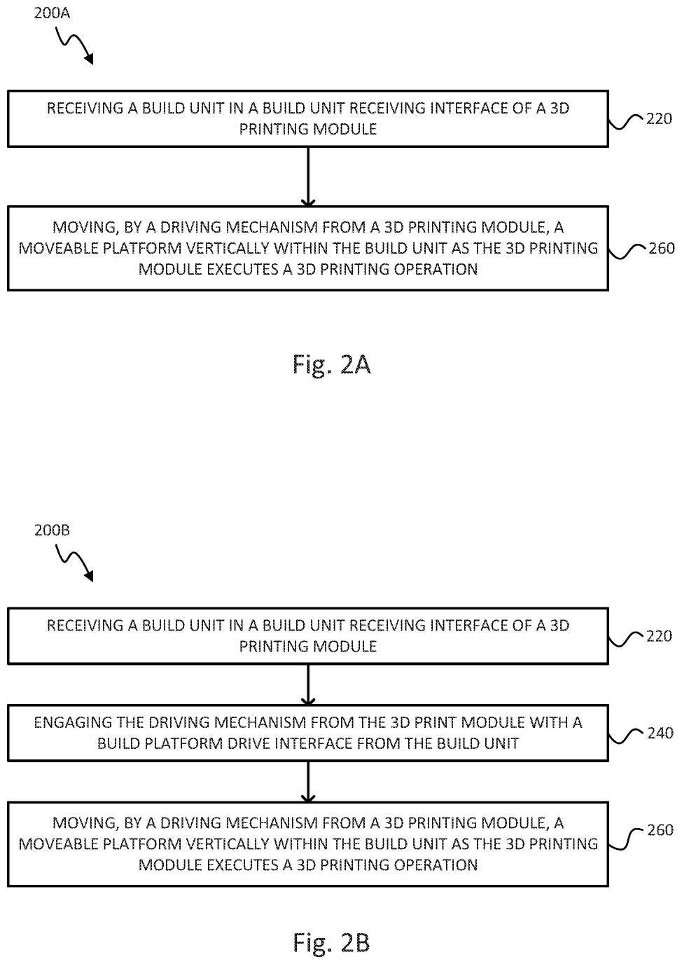

FIG. 2A is a flowchart of an example method 200A suitable for controlling interaction between the build unit 120 and, for example, the 3D printing module 100A from FIG. 1A. Method 200 may involve previously disclosed elements from FIG. 1A referred to with the same reference numerals.

At block 220, the 3D printing module 100A receives the build unit 120 in the build unit receiving interface 110 in the 3D printing module 100. The build unit 120 may be inserted into the build unit receiving interface 110 manually by a user or automatically through, for example, transportation belts or a robot. Additionally, some locking features located in the build unit receiving interface 110 and/or the build unit 120 may be actuated to hold the build unit 120 in the appropriate position within the build unit receiving interface 110. Following method 200A, block 260 is executed.

At block 260, the driving mechanism 140 from the 3D module 100A moves the moveable platform 130 vertically within the build unit 100A as the 3D printing module 100A executes a 3D printing operation.

In some examples, the 3D printing module 100A may execute at least one of the following 3D printing operations: loading the removable build unit 120 with build material, heating part of the build unit 120, selectively solidifying portions of build material from the build unit 120, ejecting agents to portions of a build material layer from the build unit 120, curing the contents of a build unit 120, selectively thermally fusing portions of the uppermost layer of build material on the build platform 130, decaking the contents of the build unit 120, recycling non-solidified build material, removing the 3D objects from the build unit 120, cleaning the build unit 120, etc.

FIG. 2B is a flowchart of an example method 200B suitable for interacting the build unit 120 with, for example, the 3D printing module 100B from FIG. 1B. Method 200B may involve previously disclosed elements from FIG. 1B and 2A referred to with the same reference numerals.

At block 220 from method 200B, the 3D printing module 100A receives the build unit 120 in the build unit receiving interface 110 from the 3D printing module 100. Block 220 may be the same as or similar to as block 220 from FIG. 2A. Following with method 200B, block 240 is executed.

At block 240, the controller 150 may control the driving mechanism 140 from the 3D print module 100B to actively engage with the build platform drive interface from the build unit 100B by, for example, activating a latching mechanism, a grip mechanism, or a pin mechanism. Following with method 200B, block 260 is executed.

At block 260, the driving mechanism 140 from the 3D module 100B moves the moveable platform 130 vertically within the build unit 120 as the 3D printing module 100B executes a 3D printing operation. Block 260 may be the same as or similar to as block 260 from FIG. 2A.

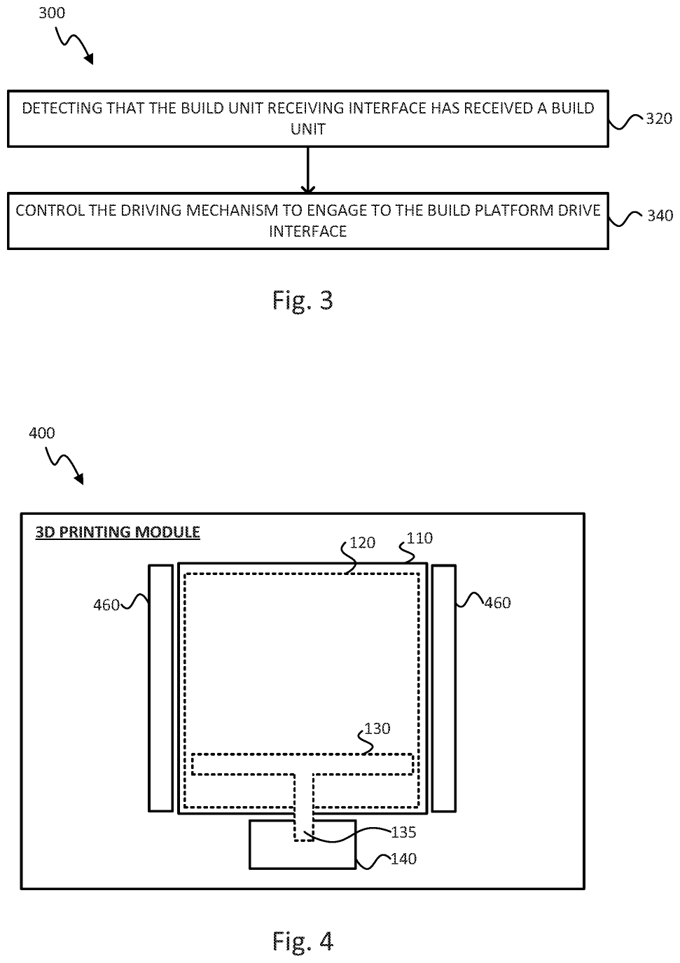

FIG. 3 is a flowchart of another example method 300 for engaging the build unit with the 3D printing module. Specifically, method 300 is to engage the driving mechanism 140 and the build platform drive interface 135 in an active manner. Method 300 may be executed by the controller 150. The controller 150 may control previously disclosed elements referred to with the same reference numerals.

At block 320, the controller 150 detects that the build unit receiving interface 110 of the 3D printing module 100B has received the build unit 120. The controller 150 may detect the correct placement of the build unit 120 through a sensor device, through electrical connectivity activation between the 3D module 100B circuitry and the build unit 120 circuitry, through the user manual input, through the activation of the a locking feature between the build unit 120 and the build unit receiving interface 110, or through similar mechanisms.

At block 340, the controller 150 controls the driving mechanism 140 to engage with the build platform drive interface 135. Upon the detection that the build unit 120 is correctly placed within the build unit receiving interface 110, the controller 150 is to activate the driving mechanism 140 (e.g., latching mechanism, grip mechanism, pin mechanism) to lock (e.g., latch, grip, pin) the driving mechanism 140 with the build platform drive interface 135.

FIG. 4 is a schematic diagram showing an example of a cross-sectional view of another 3D printing module 400. Some elements from FIG. 4 may be the same as or similar to previously disclosed elements.

The 3D printing module 400 comprises the build unit receiving interface 110 and the driving mechanism 140. The build unit receiving interface 110 is to receive a build unit 120 with a build platform 130 therein, the build platform 130 comprises the build platform drive interface 135.

The 3D printing module 400 further comprises a heating source 460 to apply heat to a part of a build unit 120 wall. The heat applied by the heating source 460 to the build unit 120 wall transfers to the inner volume of the build unit 120 (i.e., build chamber), thereby heating its contents. The heating source 460 may therefore be used as a temperature control mechanism for the contents in the build unit 120 (e.g., build chamber, generated 3D objects). The heating source 460 may include resistive heaters, heating blankets, or any suitable element capable to emit or generate heat in a controlled manner. In additional examples, the 3D printing module 400 may comprise more than one heating source 460 to apply heat to the build unit 120 wall.

In an example, the heating source 460 surrounds a portion of the build unit 120. In another example, however, the heating source 460 substantially fully surrounds the lateral walls of the build unit 120. In a further example, the heating source 460 may also apply heat to the top part of the build unit 120.

In some examples, when in use, the heating source 460 may be in direct contact with the build unit 120 wall. In other examples, however, there may be a gap between the heating source 460 and the build unit 120 wall, thereby the applied heat may travel through an intermediate medium (e.g., air) before reaching the build unit 120 wall which it is intended to transfer heat through.

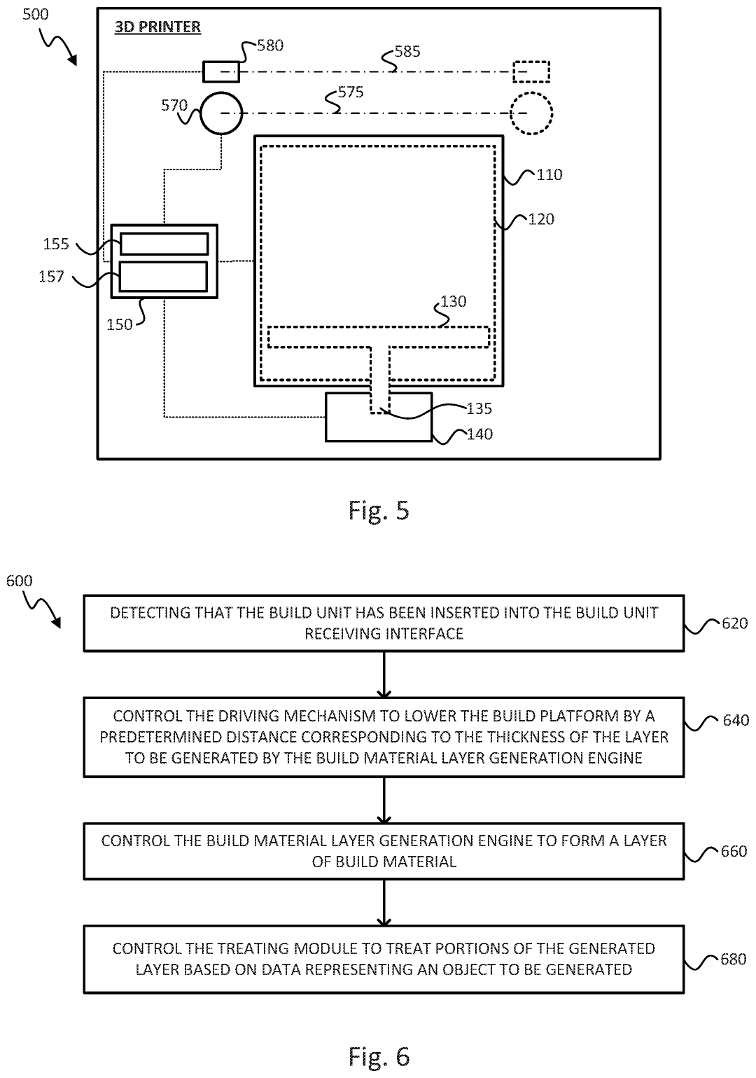

FIG. 5 is a schematic diagram showing an example of a front view vertical cross-section of a 3D printer 500. Some elements from FIG. 5 may be the same as or similar to previously disclosed elements.

The 3D printer 500 may be any 3D printing sub-system capable of processing layers of build material. In an example, the 3D printer 500 may selectively solidify portions of a layer of build material in a layer-by-layer basis by depositing printing fluids (e.g., fusing agents, fusing modifying agents, property agents, colour agents). In other examples, the 3D printer 500 may comprise a laser or a laser array to selectively solidify portions of a layer of build material; e.g., Selective Laser Sintering (SLS). In other examples, the 3D printer 500 may selectively deposit binding agents (e.g., thermally curable binder agents, UV curable binder agents) to a layer of build material in a layer-by-layer basis. In yet other examples, the 3D printer may use other 3D printing techniques to generate a 3D object, for example, Stereolithography (SLA), Digital Light Processing (DLP), Fused Deposition Modeling (FDM), Selective Laser Melting (SLM), Electronic Beam Melting (EBM), Laminated Object Manufacturing (LOM), or the like.

The 3D printer 500 comprises the build unit receiving interface 110 to receive a build unit 120 with a build platform 130, the build platform 130 comprising the build platform drive interface 135. The 3D printer 500 further comprises the driving mechanism 140 engageable with the build platform drive interface 135, the driving mechanism 140 to control the movement of the build platform 130 within the build unit 120.

The 3D printer 500 further comprises a build material layer generation engine 570 to generate layers of build material on the moveable platform 130. In some examples, the build material layer generation engine 570 is a spreader (e.g., recoating roller, wiper, doctor blade). In these examples, an additional mechanism is to supply an amount of build material from a build material reservoir to the spreader, so that the spreader can generate a layer of build material therefrom as the spreader scans over the build platform 130 (e.g., scans through direction 575). In other examples, however, the build material layer generation engine 570 is a scanning overhead hopper to deposit build material over the build platform 130 as the hopper scans above the build platform 130 (e.g., scans through direction 575), thereby generating a layer of build material.

The 3D printer 500 further comprises a processing engine 580 to selectively process portions of the uppermost layer of build material on the moveable platform 130. The processing engine 580 is at least one of a printing engine and/or a selectively solidification engine, thereby including at least one of a carriage with printheads to eject printing fluids (such as binder or fusing agents), a laser or laser array, or any other suitable 3D object generation technique generation. In some examples, the processing engine 580 is to scan over the build platform 130 (e.g., scans through direction 585) as the processing engine selectively processes the uppermost layer of build material (e.g., carriage with printheads). In other examples, however, the processing engine 580 is a fixed element above the build unit 120 with a mechanism to selectively process the uppermost layer of build material (e.g., laser, laser array).

The 3D printer 500 comprises the controller 150 coupled to the build unit enclosure 110, the driving mechanism 140, the build material layer generation engine 570, and the processing engine 580. The functionality of the controller 150 from the 3D printer 500 is disclosed and may be more fully appreciated with reference to the execution of method 600 from FIG. 6.

FIG. 6 is a flowchart of an example method 600 for generating a part of 3D object by the 3D printer 500. The method 600 may be executed by the processor 155 upon the execution of the specific instructions from the memory 157 of the controller 150 from 3D printer 500.

At block 620, the controller 150 detects that the build unit has been inserted into the build unit receiving interface.

At block 640, the controller 150 controls the driving mechanism 140 to lower the build platform 130 by a predetermined distance corresponding to the thickness of the layer to be generated by the build material layer generation engine 570. Block 640 may be similar to block 260 from FIG. 2. In some examples, the thickness of the layer to be generated may range from about 30 to about 120 microns, for example 50 microns or 80 microns.

At block 660, the controller 150 may control the build material generation engine 570 to form a layer of build material. The build material generation engine 570 may be a spreader or a hopper (see, e.g., FIG. 5), the controller 150 may control the build material generation engine 570 to scan above the build platform 130 to generate the layer of build material.

At block 680, the controller 150 may control the processing module 580 to process portions of the generated layer based on data representing a 3D object to be generated. In some examples, the controller 150 may control the processing module 580 to scan over the build platform 130 and selectively eject printing fluids (e.g., fusing agent, fusing modifying agent, property agents, color agents, binder agents). In other examples, the controller 150 may control the processing module 580 to selectively solidify portions of a layer of build material on the build platform 130 through a laser beam or an array of laser beams.

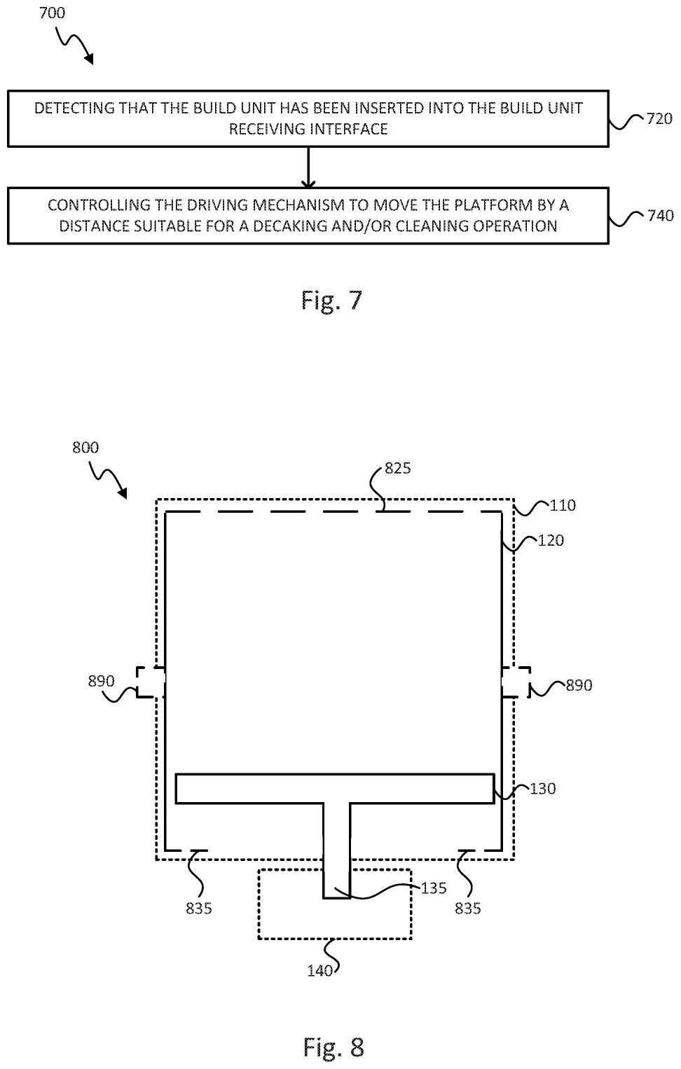

FIG. 7 is a flowchart of an example method 700 for executing a 3D printing operation by a build material processing station.

A build material processing station is a sub-system from a 3D printing system capable of handling build material and executing a wide-range of 3D printing operations. A build material processing station may receive build material cartridges or reservoirs, may load the build unit with build material, may perform decaking operations, may recycle un-solidified build material for subsequent jobs, may sieve the recycled build material prior to storing the recycled build material in recycled build material reservoirs, may clean the build unit for subsequent use, and the like.

At block 720, the controller 150 may detect that the build unit 120 has been inserted into the build unit receiving interface 110. Block 720 may be the same as or similar to block 320 from FIG. 3.

At block 740, the controller 150 may control the driving mechanism 140 to move the build platform 130 for a distance suitable for a decaking and/or cleaning operation. If the build material processing station is executing a decaking operation, the build platform 130 may be in a low position, with regards to the vertical axis, comprising a build chamber with 3D generated objects (or 3D binded objects) and un-solidified build material thereon. As the controller 150 controls the driving mechanism 140 to raise the build platform 130, an additional decaking module within the build material processing station may separate the generated 3D objects from the un-solidified build material. If the build material processing station is executing a cleaning operation, the controller 150 may control the driving mechanism 140 to lower the build platform 140 as an additional cleaning module removes any remaining build material particles and agent, so that the build unit 120 is clean for a subsequent print job.

FIG. 8 is a schematic diagram showing an example of a cross-section view vertical cross-section of a build unit apparatus 800. The build unit apparatus 800 is removable from the 3D printing module 100A-B from FIG. 1A-B and the 3D printer 500 from FIG. 5.

The build unit apparatus 800 comprises a housing 120 defining a build chamber therein. The build unit apparatus 800 is removable from different 3D printing modules from a 3D printing system, therefore the build unit apparatus 800 is to be received by a build unit receiving interface 110 from a 3D printing module (see, e.g., FIG. 1).

In some examples, the build unit apparatus 800 may be locked in the appropriate position within the build unit receiving interface 110 through an external locking mechanism 890 (e.g., latch, grip, pin). The build unit housing 120 may have a locking feature (e.g., groove) to allow the external locking feature 890 to lock the housing 120, and by extension the build unit apparatus 800, to the build unit receiving interface 110 from the 3D printing module.

The build unit apparatus also comprises the build platform 130, on top of which a set of layers of build material, including the generated 3D objects by the 3D printing system modules (e.g., 3D printer 500 from FIG. 5), are to be generated. The build platform 130 is moveable within the build chamber. The build unit apparatus 800 does not have any build platform 130 electro-mechanical driving mechanism. The build platform 130 comprises the build platform drive interface 135 engageable with an external driving mechanism 140 from a 3D printing module (e.g. 3D printing module 100A-B from FIG. 1A-B). Once engaged, the external driving mechanism 140 causes the platform to move vertically based on the requirements of the 3D printing operation that the 3D printing module 100A-B is to execute.

In an example, the build unit housing 120 is made of a material with high thermal conductivity. Materials with high thermal conductivity allow heat to be transferred therethrough more efficiently, for example, heat applied by the heating source 460 from FIG. 4. The build unit housing 120 may be made of a material with a thermal conductivity of at least 10 W/(m·K), for example, Aluminum 235 W/(m·K), Brass 109 W/(m·K), Copper 401 W/(m·K), Gold 314 W/(m·K), Iron 67 W/(m·K), Lead 35 W/(m·K), Nickel 91 W/(m·K), Silver 428 W/(m·K), Sodium 135 W/(m·K), Stainless Steel 14 W/(m·K), Steel (carbon 1%) 43 W/(m·K), Metallic Thorium 38 W/(m·K), Metallic Uranium 27.6 W/(m·K), Zirconium 22.6 W/(m·K), Zirconium alloy (1% Nb) 18 W/(m·K), or any other material suitable to transfer heat therethrough in an efficient manner.

In some examples, the external drive mechanism 140 is to engage with the build platform 130 from the lowest portion of the build material apparatus 800, thereby a bottom wall may not be suitable for such engagement operation. Therefore, in some examples, the housing 120 may further comprise a blocking element 835 located at a low portion of the build unit housing 120 to inhibit the build platform 130 to fall under the blocking element 835 and, at the same time, to enable the engagement between the external drive mechanism 140 and the build platform drive interface 135.

Additionally, or alternatively, the build unit apparatus 800 may further comprise a lid 825 to seal the contents in the build chamber from above. The lid may inhibit airborne build material to fly out the build chamber while the build unit apparatus 800 is travelling from a 3D printing module to another 3D printing module. The lid 825 may also inhibit external elements from falling into the build chamber while the build unit apparatus 800 is travelling from a 3D printing module to another 3D printing module.

As used herein, the terms “substantially” and “about” are used to provide flexibility to a range endpoint by providing a degree of flexibility. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1:A 3D printing module comprising:
a build unit receiving interface to receive a build unit comprising a build platform with a build platform drive interface; and
a driving mechanism engageable with the build platform drive interface to controllably move the build platform.

Feature set 2:A 3D printing module with feature set 1, wherein the driving mechanism automatically engages with the build platform upon the insertion of the build platform into the 3D printing module.

Feature set 3: A 3D printing module with any preceding feature set 1 to 2, further comprising a controller to: detect that the build unit receiving interface has received a build unit; and control the driving mechanism to engage to the build platform drive interface.

Feature set 4: A 3D printing module with any preceding feature set 1 to 3, wherein the driving mechanism is connected with a rotating device.

Feature set 5:A 3D printing module with any preceding feature set 1 to 4, further comprising a heating source to apply heat to a build unit wall.

Feature set 6: A 3D printing module with any preceding feature set 1 to 5, wherein the heating source is configured to surround a portion of the build unit when the build unit is received in the build unit receiving interface.

Feature set 7: A 3D printing module with any preceding feature set 1 to 6,wherein the heating source is configured to be in direct contact with the build unit wall.

Feature set 8: A 3D printing module with any preceding feature set 1 to 7, wherein the 3D printing module is a 3D printer, the 3D printer further comprising: a build material layer generation engine to generate layers of build material on the moveable platform; and a processing engine to selectively process portions of the uppermost layer of build material on the moveable platform, wherein the processing engine is at least one of a printing engine and/or a selectively solidification engine.

Feature set 9: A 3D printing module with any preceding feature set 1 to 8, further comprising a controller to: detect that the build unit has been inserted into the build unit receiving interface; control the driving mechanism to lower the platform by a predetermined distance corresponding to the thickness of the layer to be generated by the build material layer generation engine; control the build material layer generation engine to form a layer of build material; and control the processing engine to process portions of the generated layer based on data representing an object to be generated.

Feature set 10: A 3D printing module with any preceding feature set 1 to 9, wherein the 3D printing module is a build material processing station, the build material processing station further comprising a controller to: detect that the build unit has been inserted into the build unit receiving interface; and control the driving mechanism to move the platform for a distance suitable for a decaking and/or a cleaning operation.

Feature set 11: A build unit comprising:
a housing defining a build chamber;
a platform, movable within the build chamber, comprising a platform drive interface engageable with an external driving mechanism to cause the platform to move;
a locking feature to allow an external locking mechanism to lock the housing to a receiving interface of an external 3D printing module.

Feature set 12: A build unit with feature set 11, wherein the housing is made of a material with a thermal conductivity of at least 10 W/(m·K).

Feature set 13: A build unit with any preceding feature set 11 or 12, further comprising a blocking element located at a low portion of the build unit to inhibit the build platform to fall under the blocking element.

Feature set 14: A method comprising:
receiving a build unit in a build unit receiving interface of a 3D printing module; and
moving, by a driving mechanism from the 3D printing module, a moveable platform vertically within the build unit as the 3D printing module executes a 3D printing operation.

Feature set 15: A method with feature set 14, further comprising engaging the driving mechanism from the 3D print module with a build platform drive interface from the build unit.

What it is claimed is:

1. A 3D printing module comprising:
a build unit receiving interface to receive a build unit comprising a build platform with a build platform drive interface; and
a driving mechanism engageable with the build platform drive interface to controllably move the build platform.

2. The 3D printing module of claim 1, wherein the driving mechanism automatically engages with the build platform upon the insertion of the build platform into the 3D printing module.

3. The 3D printing module of claim 1, further comprising a controller to:
detect that the build unit receiving interface has received a build unit; and
control the driving mechanism to engage to the build platform drive interface.

4. The 3D printing module of claim 1, wherein the driving mechanism is connected with a rotating device.

5. The 3D printing module of claim 1, further comprising a heating source to apply heat to a build unit wall.

6. The 3D printing module of claim 5, wherein the heating source is configured to surround a portion of the build unit when the build unit is received in the build unit receiving interface.

7. The 3D printing module of claim 5, wherein the heating source is configured to be in direct contact with the build unit wall.

8. The 3D printing module of claim 1, wherein the 3D printing module is a 3D printer, the 3D printer further comprising:
a build material layer generation engine to generate layers of build material on the moveable platform; and
a processing engine to selectively process portions of the uppermost layer of build material on the moveable platform, wherein the processing engine is at least one of a printing engine and/or a selectively solidification engine.

9. The 3D printing module of claim 8, further comprising a controller to:
detect that the build unit has been inserted into the build unit receiving interface;
control the driving mechanism to lower the platform by a predetermined distance corresponding to the thickness of the layer to be generated by the build material layer generation engine;
control the build material layer generation engine to form a layer of build material; and
control the processing engine to process portions of the generated layer based on data representing an object to be generated.

10. The 3D printing module of claim 1, wherein the 3D printing module is a build material processing station, the build material processing station further comprising a controller to:
detect that the build unit has been inserted into the build unit receiving interface; and
control the driving mechanism to move the platform for a distance suitable for a decaking and/or a cleaning operation;

11. A build unit comprising:
a housing defining a build chamber;
a platform, movable within the build chamber, comprising a platform drive interface engageable with an external driving mechanism to cause the platform to move;
a locking feature to allow an external locking mechanism to lock the housing to a receiving interface of an external 3D printing module.

12. The build unit of claim 11, wherein the housing is made of a material with a thermal conductivity of at least 10 W/(m·K).

13. The build unit of claim 11, further comprising a blocking element located at a low portion of the build unit to inhibit the build platform to fall under the blocking element.

14. A method comprising:
receiving a build unit in a build unit receiving interface of a 3D printing module; and
moving, by a driving mechanism from the 3D printing module, a moveable platform vertically within the build unit as the 3D printing module executes a 3D printing operation.

15. The method of claim 14, further comprising engaging the driving mechanism from the 3D print module with a build platform drive interface from the build unit.
